(19) United States
(12) Patent Application Publication
(10) Pub. No.: US 2024/0362273 A1
(43) Pub. Date: Oct. 31, 2024

(54) SYSTEMS AND METHODS OF USING CONFIGURABLE FUNCTIONS TO HARMONIZE DATA FROM DISPARATE SOURCES

(71) Applicant: WALGREEN CO., Deerfield, IL (US)

(72) Inventors: Sibish Abraham, Long Grove, IL (US); Sunil Rodrigues, Buffalo Grove, IL (US); Surekha Durvasula, Skokie, IL (US)

(21) Appl. No.: 18/206,927

(22) Filed: Jun. 7, 2023

Related U.S. Application Data
(60) Provisional application No. 63/462,922, filed on Apr. 28, 2023.

(51) Int. Cl. G06F 16/904; G06F 16/901

(52) U.S. Cl. CPC G06F 16/904; G06F 16/901

(57) ABSTRACT

Example techniques for using configurable functions to harmonize data from disparate sources may include retrieving first and second datasets including data records with values for respective first and second sets of fields; analyzing the first and second sets of fields to identify a third set of fields included in both the first and second sets of fields; identifying data records from the first and second plurality of data records having matching values for the third set of fields; stitching the identified data records from the first and second pluralities of data records with one another in order to generate a third dataset including a third plurality of data records having values for both the first and second set of fields; applying one or more functions to the third plurality of data records of the third dataset to produce an output dataset; and displaying the output dataset via a user interface.

### FIELD OF THE INVENTION

The present disclosure generally relates to technologies associated with data analytics and curation, and more particularly, to technologies for using configurable functions to harmonize data from disparate sources.

### BACKGROUND

The background description provided herein is for the purpose of generally presenting the context of the disclosure. Work of the presently named inventors, to the extent it is described in this background section, as well as aspects of the description that may not otherwise qualify as prior art at the time of filing, are neither expressly nor impliedly admitted as prior art against the present disclosure.

It is often necessary to analyze data originating from different sources. For instance, a company may need to analyze data generated and recorded by multiple divisions within the company, or data generated by multiple partner companies. Similarly, a hospital may need to analyze data generated by other hospitals, or a company may need to analyze data generated and recorded by both the company and the hospital. In some cases, this data may include data records pertaining to the same individual, with different data about the individual generated and recorded by different entities. Currently, it is difficult to harmonize data pertaining to the same subject matter (e.g., the same individual) in datasets from different sources. The different sources may format the data differently, may label the fields differently, or may use slightly different terminology, such that in some cases even determining whether the different sources each contain data related to the same subject matter is difficult, let alone combining such data to perform any further analysis.

Existing techniques may utilize SQL code or machine learning algorithms to attempt to harmonize data from different sources to identify matching data points. However, SQL code generally only works on databases or otherwise columnar data sets. When using SQL code to finding matching data points, the hit counts tend to be low when data is collected at different times, with different context, or by different systems, different companies, etc. On the other hand, while machine learning algorithms may be capable of analyzing data collected at different times, with different context, by different systems, etc., these algorithms are probabilistic and not necessarily reliable for finding matching data points. That is, because these algorithms are probabilistic (i.e., non-deterministic), any “matching” data points identified by machine learning algorithms may include high numbers of false positives and/or false negatives, and may not be applicable for use cases that require high fidelity in their matches—such as doing refunds, or dispensation of drugs or for recommendations that are connected to health consultations. The lack of reliability means that time consuming human intervention, and additional quality checks, may be needed. Furthermore, SQL code, or machine learning algorithms, would need to be modified with every new use case and dataset. That is, these techniques are not scalable and the curation/stitching that may be performed by such techniques is not repeatable, as well as being very time intensive and error prone.

### SUMMARY

In one aspect, a computer-implemented method for using configurable functions to harmonize data from disparate sources is provided. The method may include method may include retrieving, by one or more processors, a first dataset from a first external data source, the first dataset including a first plurality of data records having values for each of a first set of fields; retrieving, by the one or more processors, a second dataset from a second external data source, distinct from the first external data source, the second dataset including a second plurality of data records having values for each of a second set of fields; analyzing, by the one or more processors, the first set of fields and the second set of fields to identify a third set of fields, the third set of fields being fields included in both the first set of fields and the second set of fields; identifying, by the one or more processors, one or more data records of the first plurality of data records, and one or more respective data records of the second plurality of data records, having matching values for the third set of fields; stitching, by the one or more processors, each identified data record of the first plurality of data records with each respective identified data record of the second plurality of data records in order to generate a third dataset including a third plurality of data records having values for each of the first set of fields and for each of the second set of fields; applying, by the one or more processors, one or more functions to the third plurality of data records of the third dataset to produce an output dataset; and displaying, by the one or more processors, the output dataset via a user interface. The method may include additional, less, or alternate actions, including those discussed elsewhere herein.

In another aspect, a computer system for using configurable functions to harmonize data from disparate sources is provided. The computer system may include one or more processors and a memory storing computer-executable instructions that, when executed by the one or more processors, cause the one or more processors to: retrieve a first dataset from a first external data source, the first dataset including a first plurality of data records having values for each of a first set of fields; retrieve a second dataset from a second external data source, distinct from the first external data source, the second dataset including a second plurality of data records having values for each of a second set of fields; analyze the first set of fields and the second set of fields to identify a third set of fields, the third set of fields being fields included in both the first set of fields and the second set of fields; identify one or more data records of the first plurality of data records, and one or more respective data records of the second plurality of data records, having matching values for the third set of fields; stitch each identified data record of the first plurality of data records with each respective identified data record of the second plurality of data records in order to generate a third dataset including a third plurality of data records having values for each of the first set of fields and for each of the second set of fields; apply one or more functions to the third plurality of data records of the third dataset to produce an output dataset; and display the output dataset via a user interface. The system may include additional, less, or alternate functionality, including that discussed elsewhere herein.

In still another aspect, a non-transitory computer-readable storage medium storing computer-readable instructions for using configurable functions to harmonize data from disparate sources is provided. The computer-readable instructions, when executed by one or more processors, cause the one or more processors to: retrieve a first dataset from a first external data source, the first dataset including a first plurality of data records having values for each of a first set of fields; retrieve a second dataset from a second external data source, distinct from the first external data source, the second dataset including a second plurality of data records having values for each of a second set of fields; analyze the first set of fields and the second set of fields to identify a third set of fields, the third set of fields being fields included in both the first set of fields and the second set of fields; identify one or more data records of the first plurality of data records, and one or more respective data records of the second plurality of data records, having matching values for the third set of fields; stitch each identified data record of the first plurality of data records with each respective identified data record of the second plurality of data records in order to generate a third dataset including a third plurality of data records having values for each of the first set of fields and for each of the second set of fields; apply one or more functions to the third plurality of data records of the third dataset to produce an output dataset; and display the output dataset via a user interface. The instructions may direct additional, less, or alternative functionality, including that discussed elsewhere herein.

Advantages will become more apparent to those of ordinary skill in the art from the following description of the preferred embodiments which have been shown and described by way of illustration. As will be realized, the present embodiments may be capable of other and different embodiments, and their details are capable of modification in various respects. Accordingly, the drawings and description are to be regarded as illustrative in nature and not as restrictive.

### BRIEF DESCRIPTION OF THE DRAWINGS

The figures described below depict various aspects of the system and methods disclosed herein. It should be understood that each figure depicts an embodiment of a particular aspect of the disclosed system and methods, and that each of the figures is intended to accord with a possible embodiment thereof.

There are shown in the drawings arrangements which are presently discussed, it being understood, however, that the present embodiments are not limited to the precise arrangements and instrumentalities shown, wherein:

FIG. 1A illustrates an example of modifier functions that can be specified in a configuration that allows the outcome of the data sets flowing through the pipelines to be changed as needed, according to some embodiments;

FIG. 1B depicts an exemplary computer system for using configurable functions to harmonize data from disparate sources, according to some embodiments;

FIG. 2 depicts a flow diagram of an exemplary computer-implemented method for data processing, as may be implemented by the system of FIG. 1B, according to some embodiments;

FIGS. 3 and 4 depict flow diagrams of an exemplary computer-implemented method for auto-detection processing, as may be implemented by the system of FIG. 1B, according to some embodiments;

FIG. 5 depicts a flow diagram of an exemplary computer-implemented method for data source onboarding, as may be implemented by the system of FIG. 1B, according to some embodiments;

FIG. 6 depicts a flow diagram of an exemplary computer-implemented method for orchestrating curation, as may be implemented by the system of FIG. 1B, according to some embodiments;

FIG. 7 depicts a flow diagram of an exemplary computer-implemented method for using configurable functions to harmonize data from disparate sources, as may be implemented by the system of FIG. 1B, according to some embodiments; and

FIG. 8 depicts an exemplary computing system in which the techniques described herein may be implemented, according to some embodiments.

While the systems and methods disclosed herein is susceptible of being embodied in many different forms, it is shown in the drawings and will be described herein in detail specific exemplary embodiments thereof, with the understanding that the present disclosure is to be considered as an exemplification of the principles of the systems and methods disclosed herein and is not intended to limit the systems and methods disclosed herein to the specific embodiments illustrated. In this respect, before explaining at least one embodiment consistent with the present systems and methods disclosed herein in detail, it is to be understood that the systems and methods disclosed herein is not limited in its application to the details of construction and to the arrangements of components set forth above and below, illustrated in the drawings, or as described in the examples.

Methods and apparatuses consistent with the systems and methods disclosed herein are capable of other embodiments and of being practiced and carried out in various ways. Also, it is to be understood that the phraseology and terminology employed herein, as well as the abstract included below, are for the purposes of description and should not be regarded as limiting.

### DETAILED DESCRIPTION

### Overview

As discussed above, existing techniques may utilize SQL code or machine learning algorithms to attempt to harmonize data from different sources to identify matching data points. However, SQL code generally only works on databases or otherwise columnar data sets. When using SQL code to finding matching data points, the hit counts tend to be low when data is collected at different times, with different context, or by different systems, different companies, etc. On the other hand, while machine learning algorithms may be capable of analyzing data collected at different times, with different context, by different systems, etc., these algorithms are probabilistic and not necessarily reliable for finding matching data points. That is, because these algorithms are probabilistic (i.e., non-deterministic), any “matching” data points identified by machine learning algorithms may include high numbers of false positives and/or false negatives, and may not be applicable for use cases that require high fidelity in their matches—such as doing refunds, or dispensation of drugs or for recommendations that are connected to health consultations. The lack of reliability means that time consuming human intervention, and additional quality checks, may be needed. Furthermore, SQL code, or machine learning algorithms, would need to be modified with every new use case and dataset. That is, these techniques are scalable and the curation/stitching that may be performed by such techniques is not repeatable, as well as being very time intensive and error prone.

To address these drawbacks, the techniques provided by the present disclosure include creating a pipeline that leverages both these techniques with a very unique context-sensitive reference information look-up. Each step refines the next and may be performed iteratively based on the hit ratio targets. Most importantly, this pipeline does not need to be newly created for each new use case and dataset, but is instead a standard pipeline that changes with the data set and the hit ratio desired. That is, no new code or alternative code is needed to analyze new datasets. Furthermore, the code components of the pipeline can be deployed independent of the data and the metadata. This pipeline is standardized, with a level of repeatability and works across multiple domains, data formats and data set sizes—millions or records or billions of records. Compared to existing techniques, the techniques provided by the present disclosure are more computationally efficient, require less user input, and result in fewer errors. Moreover, the techniques provided by the present disclosure are faster than existing techniques. The present techniques provide a framework that uses auto-detection, and includes functions for performing iterations to increase accuracy based on all the additional reference tools it has at hand. The framework provided by the present techniques is not just a codebase but a library of fairly diverse metamodels and metadata sources.

The techniques of the present disclosure provide a highly optimized data processing and transformation engine capable of curating billions of transactions on a data and analytics platform. In an example, a master driver initiator engine takes a configuration file containing instructions on what codebase, transformations, regular expressions allow data to be processed from one step to the next. The techniques of the present disclosure provide an environment for efficient data processing, data mashups, data validation and data curation. A pre-built standard library of functions may perform data harmonization across multiple sources, flatten hierarchical data, and build a domain data model in a data lake. The techniques of the present disclosure provide configurable functions and expressions for data enrichment and imputations. Using the techniques of the present disclosure, quantitative analytic outputs are produced, making use of the standard functions, and qualitative analysis is performed using configurable functions to produce metrices and data products that are reliable and valid. The techniques of the present disclosure provide the ability to add custom functions, which helps to tailor fit data processing and transformation logic depending on the data characteristics, enabling unbiased inference from data and effective and efficient data cohorts. The techniques of the present disclosure may be helpful in targeting clinical trials for all demographics of a population. The techniques of the present disclosure provide may also help to draw insights by juxtaposing analytical product outcomes against one another.

In an example, a data lake cataloging function module may integrate the data lake data set with an analytics platform data catalog. A processor may read a configuration file and map that configuration file to executable code. Furthermore, a user-defined function executor module may read a user-defined instruction file and map that user-defined instruction file to executable code. Additionally, an expression builder module may read filter statements and pattern-finding instructions defined by user and map those filter statements and pattern-finding instructions to executable code

SQL cards (which may be, in various implementations, regular expression cards, pattern matching cards, data manipulation cards, calculation cards, etc.) may be assembled in order to divert datasets to specific workflow pathways. The SQL cards may carry any logic, and the logic may be independently validated and approved by users, resulting in a data pipeline that is auditable and is predictable.

In general, the techniques provided by the present disclosure are not just based on pre-existing templates that are available at the time of installation of partner integrations, but are more dynamic. In particular, the techniques provided by the present disclosure can include modifying the flow by changing functions during processing and discovering the nuances of data completeness and data quality at run-time. This dynamic on-demand enlisting of functions provided by the techniques of the present disclosure is a key differentiator from existing techniques. The context of data and the quality of the datasets being merged are the two key levers that alter the flow of functions used in the techniques of the present disclosure. The techniques provided by the present disclosure may allow the user to provide instructions to describe the context of the incoming dataset, and allow the user to specify what special data modifier functions need to be applied at runtime.

Specifically, the techniques provided by the present disclosure may include steps (described in greater detail below) of inferring metadata, discovering a schema, profiling data, inferring concepts/entities, detecting data drift, inferring data completeness by comparing live data with metadata, identifying appropriate data transformation function(s) or data split function(s) to apply to the data based on the type of any data gap or data skewedness, inferring the quality of the data by comparing live data with the data drift, identifying an appropriate reference data lookup function, data computation function, data transposition function, or data translation function (based on the availability of external reference data to address data skewedness), and identifying appropriate data quality logic from the discovered schema.

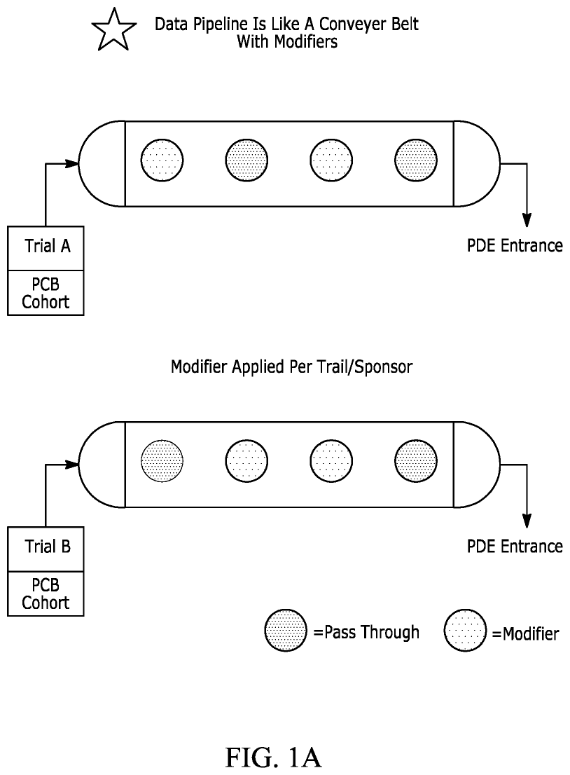

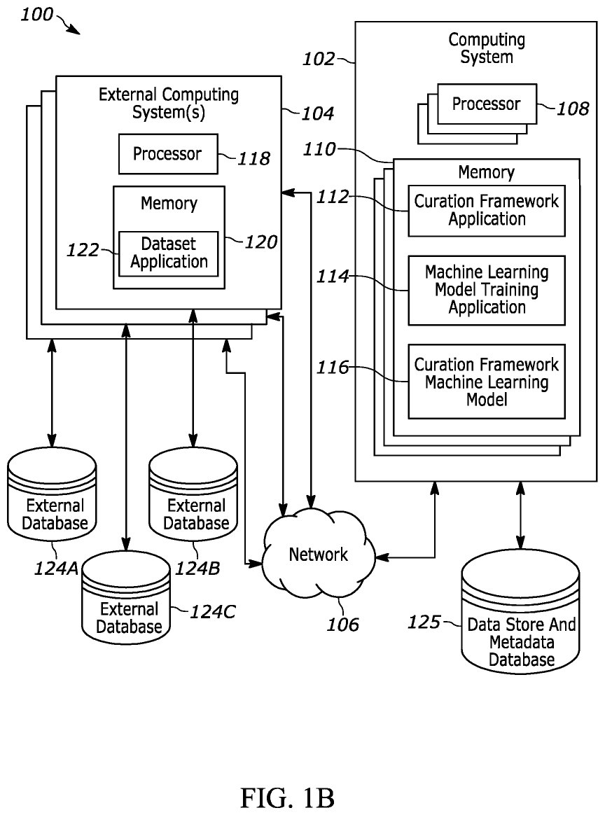

Using the present techniques, these steps may be repeated for each data set to identify how to discover schemas to link the two datasets together to stitch them to one another. For instance, an on-demand modifier function may be applied, without requiring changes or modifications to the code itself. If an instruction set does not exist, the stitched data set is final, and is provided as an output. If an instruction set does exist, a chain of modifier functions may be mapped to the instruction set, e.g., as shown at FIG. 1A, including, for instance, any of the following: additional SQL queries to add internal context data, additional inserts to the schema to process the data set through another data pipeline to augment the stitched data set with new attributes, additional filter options for the stitched dataset, additional split logic to be applied to the stitched dataset to break it does and push it to different systems/users, additional look-up of external data to be added to augment the stitched dataset, additional machine learning algorithms to recommend additional attributes to be added to the stitched dataset, additional machine learning engineering features to allow the stitched dataset to become a training dataset for another machine learning model, etc.

Example System for Using Configurable Functions to Harmonize Data from Disparate Sources

FIG. 1B depicts an exemplary computer system 100 for using configurable functions to harmonize data from disparate sources, according to one embodiment. The high-level architecture illustrated in FIG. 1B may include both hardware and software applications, as well as various data communications channels for communicating data between the various hardware and software components, as is described below.

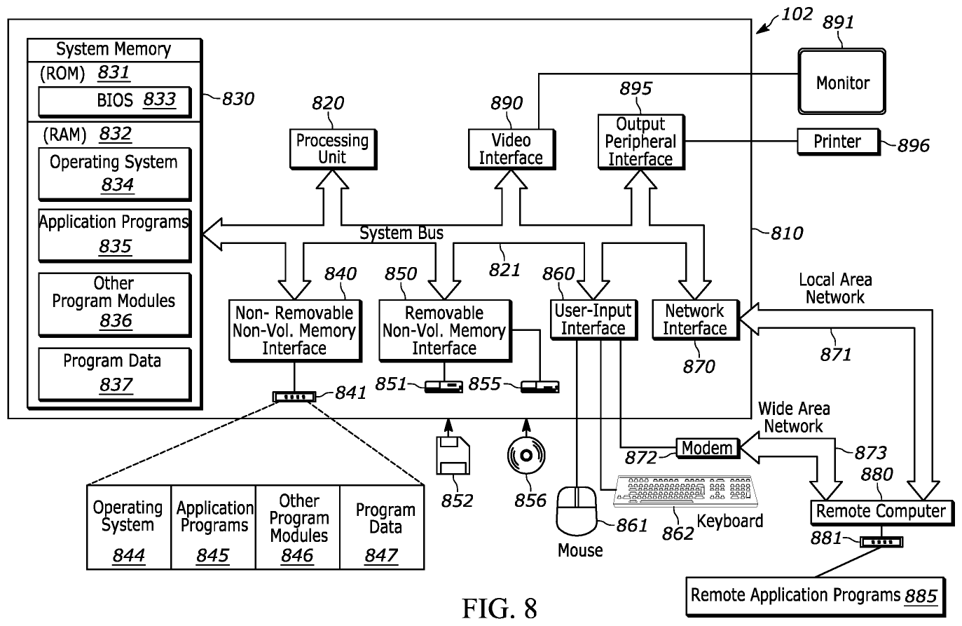

The system 100 may include a computing system 102, which is described in greater detail below with respect to FIG. 8, as well as a plurality of external computing systems 104. The computing system 102 and external computing systems 104 may be configured to communicate with one another via a wired or wireless computer network 106. To facilitate such communications the computing system 102 and external computing systems 104 may each respectively comprise a wireless transceiver to receive and transmit wireless communications. Although one computing system 102 and three external computing system 104, and one network 106 are shown in FIG. 1B, any number of such computing systems 102, external computing systems 104, and networks 106 may be included in various embodiments.

In some embodiments the computing system 102 may comprise one or more servers, which may comprise multiple, redundant, or replicated servers as part of a server farm. In still further aspects, such server(s) may be implemented as cloud-based servers, such as a cloud-based computing platform. For example, such server(s) may be any one or more cloud-based platform(s) such as MICROSOFT AZURE, AMAZON AWS, or the like. Such server(s) may include one or more processor(s) 108 (e.g., CPUs) as well as one or more computer memories 110.

Memories 110 may include one or more forms of volatile and/or non-volatile, fixed and/or removable memory, such as read-only memory (ROM), electronic programmable read-only memory (EPROM), random access memory (RAM), erasable electronic programmable read-only memory (EEPROM), and/or other hard drives, flash memory, MicroSD cards, and others. Memorie(s) 110 may store an operating system (OS) (e.g., Microsoft Windows, Linux, UNIX, etc.) capable of facilitating the functionalities, apps, methods, or other software as discussed herein. Memorie(s) 110 may also store a curation framework application 112, a curation framework machine learning model 114, and/or a curation framework machine learning model training application 116.

Additionally, or alternatively, the memorie(s) 110 may store historical data from various sources, such as from historical datasets, including the structures/schemas of the historical datasets, the fields of the historical datasets and the values included in those fields, the formatting of various values in the historical datasets, any functions that were applied to the historical datasets, the way the historical datasets were stitched to other historical datasets, and/or data associated with individuals in the historical datasets. The historical data may also be stored in a data store and metadata database 125, which may be accessible or otherwise communicatively coupled to the computing system 102. In some embodiments, the pipeline application data or other data from various sources may be stored on one or more blockchains or distributed ledgers.

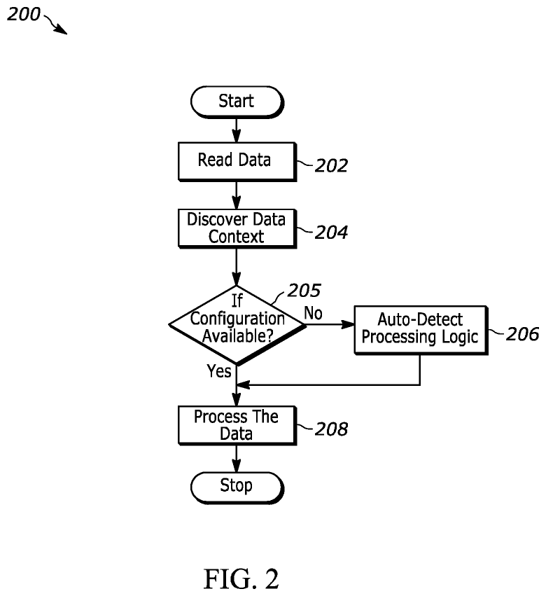

Executing the curation framework application 112 may include receiving/retrieving two or more datasets from two or more external computing systems 104. The curation framework application 112 may analyze the two or more datasets using the techniques of methods 200, 300, 500, 600 and 700, discussed in greater detail below with respect to the flow diagrams shown at FIGS. 2-7, in order to identify the structure of each dataset and the types of fields and values included in each dataset, and may use this analysis to stitch the two or more datasets together based on common values, e.g., data records in multiple different datasets that area each related to the same person who is both a customer at a store, a patient at a pharmacy, a patient at a hospital, etc. Furthermore, the curation framework application 112, using the techniques of methods 200, 300, 500, 600 and 700, may determine the quality of the data from the various datasets, and whether any functions must be applied to the data from the various datasets in order to stitch the datasets together, or in order to further analyze the stitched datasets. Ultimately, the curation framework application 112, using the techniques of methods 200, 300, 500, 600 and 700, may generate one or more recommendations or predictions based on the stitched dataset, and may display such recommendations or predictions via a user interface display (not shown) and/or transmit such recommendations or predictions to external computing systems, such as the external computing system(s) 104.

Furthermore, in some examples, the analysis discussed above as being performed by the curation framework application 112 may be based upon applying a trained curation framework machine learning model 116 to the data from the datasets. For instance, the trained curation framework machine learning model 116 may be used to identify a schema or structure for a dataset, to identify fields of the dataset based on their values, to determine appropriate formatting for particular values, to identify functions or transformations to be applied to a dataset, to stitch the dataset with another dataset, and/or to make a prediction or recommendation for an individual associated with a data record in the stitched dataset.

In some examples, the curation framework machine learning model 116 may be executed on the computing system 102, while in other examples the curation framework machine learning model 116 may be executed on another computing system, separate from the computing system 102. For instance, the computing system 102 may send the data from the datasets to another computing system, where the trained curation framework machine learning model 116 is applied to the data from the datasets, and the other computing system may send an identification of a schema or structure for the dataset, an identification of one or more fields of the dataset, an identification or determination of functions or transformations to be applied to the dataset, and/or a prediction or recommendation for an individual associated with a data record in the stitched dataset, based upon applying the trained curation framework machine learning model 116 to the data from the datasets, to the computing system 102, e.g., via the network 106. Moreover, in some examples, the curation framework machine learning model 116 may be trained by a curation framework machine learning model training application 114 executing on the computing system 102, while in other examples, the curation framework machine learning model 116 may be trained by a machine learning model training application executing on another computing system, separate from the computing system 102.

Whether the curation framework machine learning model 116 is trained on the computing system 102 or elsewhere, the curation framework machine learning model 116 may be trained by the curation framework machine learning model training application 114 using training data corresponding to historical datasets, their structures/schemas, their fields and values therein, the formatting associated with the values, any functions that were applied to the historical datasets, the way the historical datasets were stitched to other historical datasets, and/or data associated with individuals in the historical datasets. The trained curation framework machine learning model 116 may then be applied to the data from the datasets in order to determine, e.g., a schema or structure for the dataset, one or more fields of the dataset, functions or transformations to be applied to the dataset, and/or a prediction or recommendation for an individual associated with a data record in the stitched dataset.

In various aspects, the curation framework machine learning model 116 may comprise a machine learning program or algorithm that may be trained by and/or employ a neural network, which may be a deep learning neural network, or a combined learning module or program that learns in one or more features or feature datasets in particular area(s) of interest. The machine learning programs or algorithms may also include natural language processing, semantic analysis, automatic reasoning, regression analysis, support vector machine (SVM) analysis, decision tree analysis, random forest analysis, K-Nearest neighbor analysis, naïve Bayes analysis, clustering, reinforcement learning, and/or other machine learning algorithms and/or techniques.

In some embodiments, the artificial intelligence and/or machine learning based algorithms used to train the curation framework machine learning model 116 may comprise a library or package executed on the computing system 102 (or other computing devices not shown in FIG. 1B). For example, such libraries may include the TENSORFLOW based library, the PYTORCH library, and/or the SCIKIT-LEARN Python library.

Machine learning may involve identifying and recognizing patterns in existing data (such as training a model based on historical datasets, their structures/schemas, their fields and values therein, the formatting associated with the values, any functions that were applied to the historical datasets, the way the historical datasets were stitched to other historical datasets, and/or data associated with individuals in the historical datasets) in order to facilitate making predictions or identification for subsequent data (such as using the curation framework machine learning model 116 on new data from the datasets received from the external computing device(s) 104 in order to identify a schema or structure for the dataset, to identify fields of the dataset based on their values, to determine appropriate formatting for particular values, to identify functions or transformations to be applied to a dataset, to stitch the dataset with another dataset, and/or to make a prediction or recommendation for an individual associated with a data record in the stitched dataset.

Machine learning model(s) may be created and trained based upon example data (e.g., “training data”) inputs or data (which may be termed “features” and “labels”) in order to make valid and reliable predictions for new inputs, such as testing level or production level data or inputs. In supervised machine learning, a machine learning program operating on a server, computing device, or otherwise processor(s), may be provided with example inputs (e.g., “features”) and their associated, or observed, outputs (e.g., “labels”) in order for the machine learning program or algorithm to determine or discover rules, relationships, patterns, or otherwise machine learning “models” that map such inputs (e.g., “features”) to the outputs (e.g., labels), for example, by determining and/or assigning weights or other metrics to the model across its various feature categories. Such rules, relationships, or otherwise models may then be provided subsequent inputs in order for the model, executing on the server, computing device, or otherwise processor(s), to predict, based upon the discovered rules, relationships, or model, an expected output.

In unsupervised machine learning, the server, computing device, or otherwise processor(s), may be required to find its own structure in unlabeled example inputs, where, for example multiple training iterations are executed by the server, computing device, or otherwise processor(s) to train multiple generations of models until a satisfactory model, e.g., a model that provides sufficient prediction accuracy when given test level or production level data or inputs, is generated. The disclosures herein may use one or both of such supervised or unsupervised machine learning techniques.

In addition, memories 110 may also store additional machine readable instructions, including any of one or more application(s), one or more software component(s), and/or one or more application programming interfaces (APIs), which may be implemented to facilitate or perform the features, functions, or other disclosure described herein, such as any methods, processes, elements or limitations, as illustrated, depicted, or described for the various flowcharts, illustrations, diagrams, figures, and/or other disclosure herein. For instance, in some examples, the computer-readable instructions stored on the memory 110 may include instructions for carrying out any of the steps of the methods 200, 300, 500, 600, and/or 700 via an algorithm executing on the processors 108, which are described in greater detail below with respect to FIGS. 2, 3-4, 5, 6, and 7, respectively. It should be appreciated that one or more other applications may be envisioned and that are executed by the processor(s) 108. It should be appreciated that given the state of advancements of mobile computing devices, all of the processes functions and steps described herein may be present together on a mobile computing device.

In some embodiments the external computing system(s) 104 may comprise one or more servers, which may comprise multiple, redundant, or replicated servers as part of a server farm. In still further aspects, such server(s) may be implemented as cloud-based servers, such as a cloud-based computing platform. For example, such server(s) may be any one or more cloud-based platform(s) such as MICROSOFT AZURE, AMAZON AWS, or the like. Such server(s) may include one or more processor(s) 118 (e.g., CPUs) as well as one or more computer memories 120.

Memories 120 may include one or more forms of volatile and/or non-volatile, fixed and/or removable memory, such as read-only memory (ROM), electronic programmable read-only memory (EPROM), random access memory (RAM), erasable electronic programmable read-only memory (EEPROM), and/or other hard drives, flash memory, MicroSD cards, and others. Memorie(s) 120 may store an operating system (OS) (e.g., Microsoft Windows, Linux, UNIX, etc.) capable of facilitating the functionalities, apps, methods, or other software as discussed herein. Memorie(s) 120 may also store a dataset application 122.

Additionally, or alternatively, the memorie(s) 120 may store various datasets, which may be specific to each external computing system 104. The datasets may also be stored in a external databases 124A, 124B, 124C, etc., which may be accessible or otherwise communicatively coupled to respective external computing system(s) 104. In some embodiments, the external datasets may be stored on one or more blockchains or distributed ledgers.

Generally speaking, the dataset application 122 may send an external dataset to the computing system 102 (e.g., based on a request from the computing system 102), and may ultimately receive, from the computing system 102, a recommendation based on the analysis of the dataset by the curation framework application 112, as discussed in greater detail above. In addition, memories 120 may also store additional machine readable instructions, including any of one or more application(s), one or more software component(s), and/or one or more application programming interfaces (APIs), which may be implemented to facilitate or perform the features, functions, or other disclosure described herein, such as any methods, processes, elements or limitations, as illustrated, depicted, or described for the various flowcharts, illustrations, diagrams, figures, and/or other disclosure herein. It should be appreciated that given the state of advancements of mobile computing devices, all of the processes functions and steps described herein may be present together on a mobile computing device.

### Example Method for Data Processing

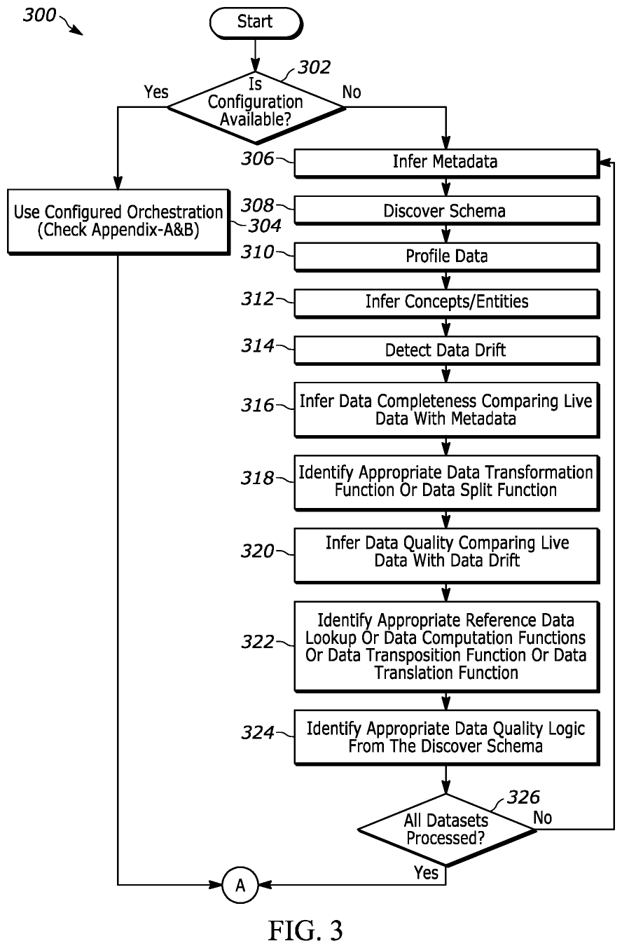

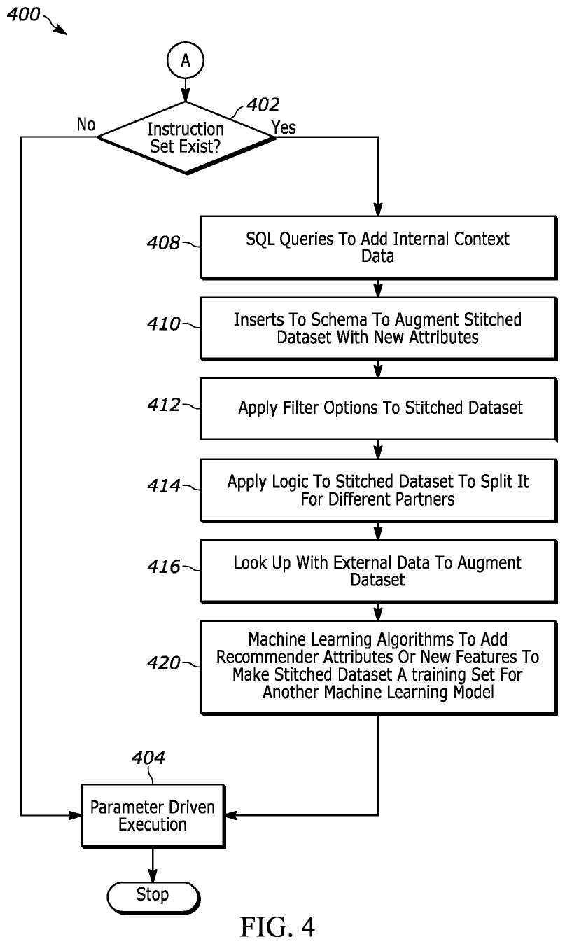

FIG. 2 depicts a flow diagram of an exemplary computer-implemented method 200 for data source onboarding, according to one embodiment. One or more steps of the method 200 may be implemented as a set of instructions stored on a computer-readable memory (e.g., memory 110) and executable on one or more processors (e.g., processor 108). The method 200 may include reading data (block 202), discovering the data context (block 204), and determining whether a configuration is available (block 205). If no configuration is available (block 205, NO), the method 200 may include auto-detecting processing logic (block 206) which is discussed in greater detail below with respect to FIGS. 3 and 4, and processing the data (block 208). If a configuration is available (block 205, YES), the method 200 may proceed to process the data at block 208 after block 205. The method 200 may include additional or alternative steps in various embodiments.

### Example Method for Auto-Detection Processing

FIGS. 3 and 4 depict flow diagrams of an exemplary computer-implemented method 300 for auto-detection processing, according to one embodiment. One or more steps of the method 300 may be implemented as a set of instructions stored on a computer-readable memory (e.g., memory 110) and executable on one or more processors (e.g., processor 108).

The method 300 may include analyzing a dataset, or multiple datasets, and determining (block 302) if a configuration associated with the dataset(s) is available. If there is a configuration available (block 302, YES), the method 300 may proceed to block 304, where a configured orchestration is used. The method 300 may then proceed to block 402, discussed in greater detail below with respect to FIG. 4.

If no configuration is available (block 302, NO), the method 300 may include inferring (block 306) metadata. For example, metadata may be inferred for both the attribute level data value, and/or for a column name. At the attribute level data value, metadata may be “inferred” based on a pattern of data. For example, a data value of “123-45-6789” may be compared to known patterns for various fields/attributes, e.g., using regular expressions or using a pattern matching machine learning algorithm (as discussed above with respect to the curation framework machine learning model 116), in order to determine that the data value is a social security number. Similarly, at the column name level, the name of a column of a dataset may be inferred based on comparing the name of the column or the data within the column to name reference metadata using regular expressions or a pattern matching machine learning algorithm, to determine, for instance, whether the column contains a particular type of information, e.g., name information or role information, with the former dealing with information about a single person and the latter dealing with information about a person's role. The pattern matching machine learning libraries that may be used to infer the metadata may be reusable and may be applied to different datasets.

The method 300 may further include discovering (block 308) a schema for the dataset. Generally speaking, the schema pertains to the data structure of the dataset, i.e., how the formatting of the data records repeat across all of the columns of the dataset. For example, based on columns in a dataset with a particular value repeating, such as “patient_name” repeating on a record that embeds “script_header,” which in turn embeds “script_details,” the data set may be inferred to be information pertaining to a patient that takes a particular medication, and the data may be inferred to be related to a patient drug dosage, drug dispensation, drug reactions etc. Using reusable machine learning record scanning libraries, the method 300 may identify repeated sections of the data and infer patterns across the sections on a JSON or XML dataset, in order to infer a schema that may be tied back to the incoming dataset.

Additionally, the method 300 may include profiling (block 310) the data of the dataset. For instance, the data of the dataset may be compared to historical data from historical datasets. For example, using the inferred/discovered schema of the dataset from block 308, other datasets with the same or similar schemas may be identified and compared to the dataset. For instance, if the schema is inferred to be related to a patient, it may be compared to historical datasets related to patients in order to identify common/repeated sections, such as a patient information section, a drug/medication section, a dosage section, an adverse reaction section, etc. As another example, if the schema is inferred to be related to person's role, it may be compared to historical datasets including categories such as name, role, age, education, work experience, etc. For instance, the method 300 may profile the dataset, using the structure of the file, to connect it back to a “resume” or “competency”.

Once the method 300 infers the structure of the dataset and matches the dataset to another dataset with one or more of the same sections, the method 300 may infer “entities” or concepts” of the dataset (block 312). Using machine learning and/or natural language processing, the method 300 may map the dataset to other datasets or elements of other datasets that include other information that maps to that structure and make further determinations, including a determination of the origin of the other datasets that map to the structure, and whether the data may be processed or must be passed to another system for processing. For instance, the “competency” dataset discussed above may be connected to metadata context from other datasets which includes the person's name, as well as categories such as “store”/“facility”, “role at facility,” “years of employment,” “job identification,” “job application type,” etc. As another example, a patient dataset may include a patient entity as well as an another related entity of drug/medication, which in turn has related entity of dosage, dispensation and reaction. In this way, the method 300 may, for instance, map a patient who is prescribed a particular drug to a reaction associated with that drug.

Furthermore, the method 300 may detect (block 314) data drift associated with the dataset. For instance, in some cases, data drift may include the evolution of a usage term, such as gender or ethnicity, over time, in which case data drift may indicate that reference information may need to be updated to reflect the newer usage of the term, e.g., for a more current list of gender types or ethnicities. In other cases, data drift may be a change in data values over time, such as a number of total sales over time, in which case, data drift may be indicative of a trend. For instance, the method 300 may compare a total number of sales by channel over time to one another to determine a trend in the data. E.g., that total sales have not gone down, but rather, in-store sales have gone down, and online sales have increased. Another example of data drift that may be detected by the method 300 may be a change from product-specific terminology to customer behavior-specific terminology. Upon detecting such changes, the method 300 may be updated to include more terminology of the type that is more common, in order to derive more accurate and useable inferences from the data.

The method 300 may infer (block 316) data completeness comparing live data with the metadata. That is, the actual data values (e.g., patient names) may be compared to the metadata or field for each value (e.g., “patient name” metadata). This metadata to which the live data is compared may also include an explanation that comes in on the envelope or header explaining the purpose of an incoming dataset (e.g., with metadata categories of name, date, size of the records to be expected, the partner number etc.), or the context of the incoming dataset (e.g., a point of sale terminal number, point of terminal device number, etc.). The metadata to which the live data is compared may also include stored information, such as a listing of products sold in a store, drug codes associated with drugs/medications, medical diagnosis codes associated with patient diagnoses, etc. The method 300 may map this metadata back to the live data with which it is associated in order to ensure the integrity of the data. This process may involve the use of natural language processing for descriptive terms, as well as a search to locate exact matches to identifiers such as loyalty identification numbers, customer identifications, patient identification numbers, etc.

The method 300 may identify (block 318) any data transformation functions or data split functions that may be appropriate for the dataset. For instance, certain incoming data may be stored in a dataset as a number, but maybe transformed to a data string, or vice versa (e.g., to facilitate comparison with other data from another dataset, to facilitate the application of a function to the data value, etc.). For example, a data value from an incoming database may be stored as a string and may be converted to a date so that further calculations such as years of tenure at the company for an employee, total lifetime value for a customer from customer sales, etc., may be calculated based on the data value. Moreover, this determination of appropriate transformation functions may be used to flag errors, such as an expected dollar value stored as a string.

Data split functions may include splitting a given data value into multiple data values. For example, a nine-digit zip code may be split into a five-digit zip code and a four-digit zip code. For instance, the five-digit zip code may be easier to compare and integrate with other data values. Moreover, the five-digit zip code may preserve the privacy of an individual, as some nine-digit zip codes include a very small population size, making it easy to identify a specific person. Moreover, data split functions may be based on metadata coming in as part of a header or instructions captured by a partner. For instance, some data from an initial incoming dataset may ultimately be sent to one data repository, recipient, or external partner, while other data from that initial incoming dataset may be sent to another data repository, recipient, or external partner. For example, for a dataset with patient data and medical diagnosis data associated with a patient, the patient data may be sent to a pharmacy system or repository associated with a patient, while medical diagnosis information may be sent to a patient provider associated with the patient.

The method 300 may infer (block 320) the quality of the data from the dataset by comparing the live data with the data drift. For instance, potential errors may be identified as errors or instances of data drift. When a live data value should be a zip code, the method 300 may flag the live data value as invalid based on being an invalid zip code for a given address, and/or based on being an invalid number of digits for a zip code, such as six digits. On the other hand, a potential error may be flagged when an incoming dataset includes a new allergy condition term that has not appeared in previous datasets. However, the method 300 may determine that this is an instance of data drift rather than an error, and add the new allergy condition term for future use.

Furthermore, the method 300 may identify (block 322) any appropriate reference data lookup functions, data computation functions, data transposition functions, or data translation functions for the dataset. Moreover, the method 300 may identify (block 324) appropriate data quality logic from the discovered schema.

If all datasets are not yet processed (block 324, NO), the method 300 may proceed to block 306 with any additional datasets. If all datasets have been processed (block 324, YES), the method 300 may proceed to block 402, where the method 300 may determine whether an instruction set exists (block 402). If not (block 402, NO), the method 300 may use parameter driven execution (block 404) to process the data.

If an instruction set exists (block 402, YES), the method 300 may use SQL queries to add internal context data (block 408). The method 300 may insert (block 410) the internal context data to the schema to augment a stitched dataset with new attributes. Furthermore, the method 300 may apply (block 412) filter options to the stitched dataset. Additionally, the method 300 may apply (block 414) split logic to the stitched dataset to split the dataset between different partners. The method 300 may look up (block 416) external data and augment the dataset with the external data. Moreover, the method 300 may apply (block 420) machine learning algorithms to the dataset to add recommender attributes or new features and make the stitched dataset a training dataset for another model. The method 300 may then use parameter driven execution (block 404) to process the data.

The method 300 may include additional or alternative steps in various embodiments.

### Example Method for Data Source Onboarding

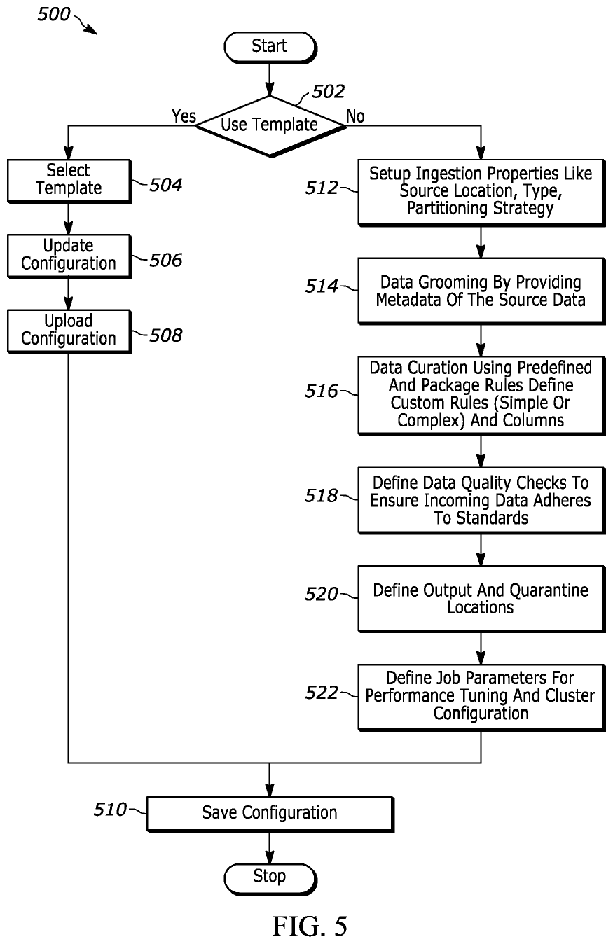

FIG. 5 depicts a flow diagram of an exemplary computer-implemented method 500 for data source onboarding, according to one embodiment. One or more steps of the method 500 may be implemented as a set of instructions stored on a computer-readable memory (e.g., memory 110) and executable on one or more processors (e.g., processor 108).

The method 500 may include determining whether to use a template (block 502, YES), or not use a template (block 502, NO). If a template is to be used (block 502, YES), the method 500 may include selecting (block 504) a template, updating (block 506) a configuration, uploading the configuration (block 508), and saving the configuration (block 510).

If a template is not used (block 502, NO), the method 500 may include setting up (block 512) ingestion properties, such as source location, type, and partitioning strategy. The method 500 may perform data grooming (block 514) by providing metadata of the source data. Furthermore, the method 500 may curate (block 516) the data using predefined and package rules. For instance, custom rules (simple or complex) and columns may be defined. Additionally, the method 500 may define (block 518) data quality checks to ensure that incoming data adheres to standards. Moreover, the method 500 may define (block 520) data output locations, and quarantine locations. Moreover, the method 500 may define (block 522) job parameters for performance tuning and cluster configuration. Finally, the method 500 may include saving (block 510) the configuration.

The method 500 may include additional or alternative steps in various embodiments.

### Example Method for Orchestrating Curation

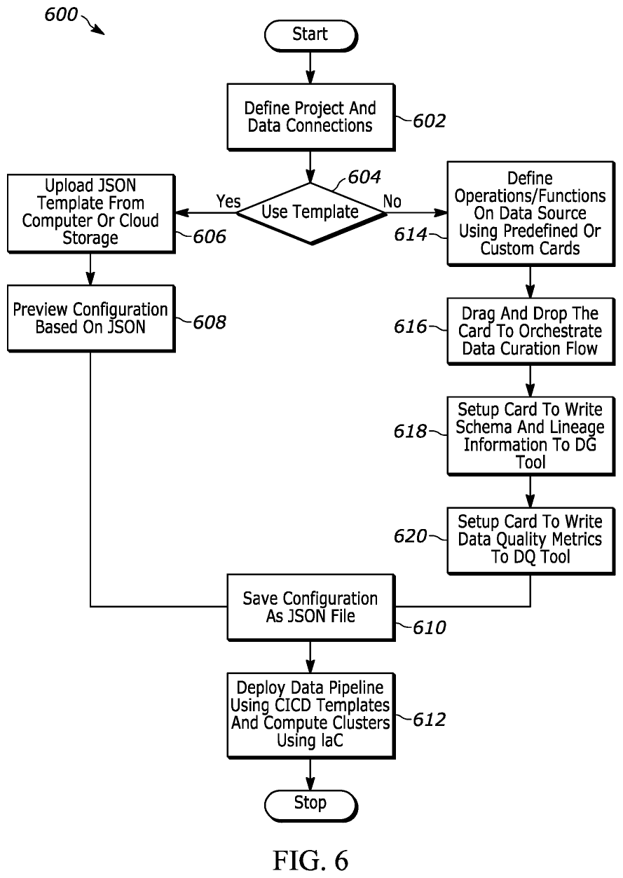

FIG. 6 depicts a flow diagram of an exemplary computer-implemented method 600 for orchestrating curation, according to one embodiment. One or more steps of the method 600 may be implemented as a set of instructions stored on a computer-readable memory (e.g., memory 110) and executable on one or more processors (e.g., processor 108).

The method 600 may include defining (block 602) a project and its related data connections. In some examples, the method 600 may use a template (block 604, YES). In such cases, the method 600 may upload (block 606) the JSON template, preview (block 608) the configuration based on the JSON template, save (block 610) the configuration as a JSON file, and configure (block 612) a data pipeline and compute a cluster using infrastructure as code (IAC).

In other examples, the method may not use a template (block 604, NO). In such cases, the method 600 may define (block 614) operations and functions based on a data source, using predefined or custom cards. The method 600 may include dragging and dropping (block 616) the cards to orchestrate a data curation flow. Furthermore, the method 600 may include setting up (block 618) the cards to write schema and lineage information to a DG tool. Moreover, the method 600 may include setting (block 620) up the cards to write data quality metrics to a DQ tool. Then, as discussed above, the method 600 may save (block 610) the configuration as a JSON file, and configure (block 612) a data pipeline and compute a cluster using infrastructure as code (IAC).

The method 600 may include additional or alternative steps in various embodiments.

Example Method for Using Configurable Functions to Harmonize Data from Disparate Sources

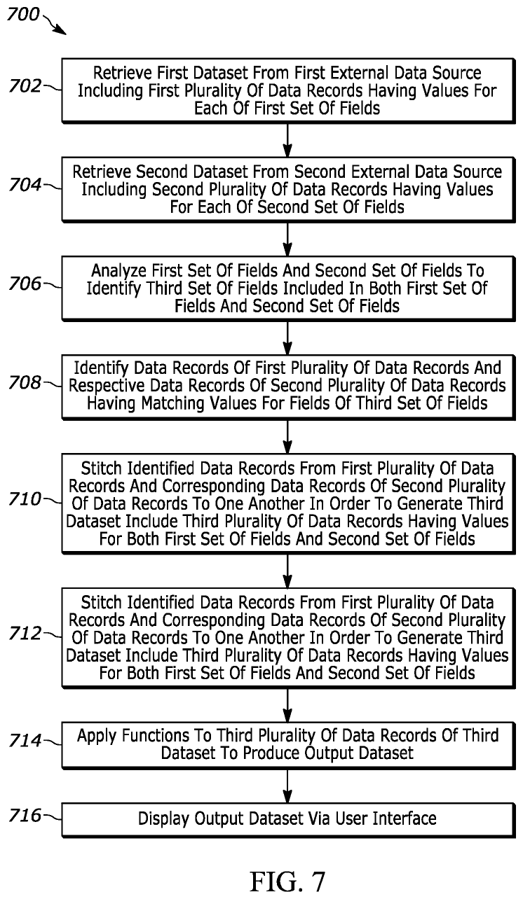

FIG. 7 depicts a flow diagram of an exemplary computer-implemented method 700 for using configurable functions to harmonize data from disparate sources, according to one embodiment. One or more steps of the method 700 may be implemented as a set of instructions stored on a computer-readable memory (e.g., memory 110) and executable on one or more processors (e.g., processor 108).

The method 700 may include retrieving (block 702) a first dataset from a first external data source (e.g., from a first retail store, a first pharmacy, a first hospital, a first research institution, etc.). The first dataset may include a first plurality of data records having values for each of a first set of fields. For instance, a data record associated with an individual who is a patient at a pharmacy may include values for a “patient name” field, a “diagnosis” field, an “insurance” field, a “patient address” field, a “patient phone number” field, a “doctor” field, etc.

The method 700 may further include retrieving (block 704) a second dataset from a second external data source (e.g., from a second retail store, a second pharmacy, a second hospital, a second research institution, etc.). The second dataset may include a second plurality of data records having values for each of a second set of fields. The second data source may be distinct from the first external data source. For instance, a data record associated with an individual who is a customer at a store may include values for a “customer name” field, a “loyalty identification number” field, a “customer address” field, a “customer phone number” field, an “purchases” field, etc.

In some examples, the method 300 may further include analyzing the first dataset in order to identify the first set of fields and/or analyzing the second dataset in order to identify the second set of fields. In particular, in some examples, the values within a given field in each dataset may be analyzed using machine learning techniques in order to identify the respective fields associated with each value. In other examples, the fields of the first and/or second dataset may be previously identified before implementing the method 700.

Additionally, the method 700 may include analyzing (block 706) the first set of fields and the second set of fields to identify a third set of fields that are included in both the first set of fields and the second set of fields. For instance, a first dataset including data records for pharmacy patients and the second dataset including data records for store customers, the third set of fields that are in common between the data records of the two datasets may include a “patient name”/“customer name” field, the “patient phone number”/“customer phone number” field, and the “patient address”/“customer address” field.

Moreover, the method 700 may include identifying (block 708) one or more data records of the first plurality of data records, and one or more respective data records of the second plurality of data records, having matching values for fields of the third set of fields. In some examples, the method 700 may convert (e.g., by applying one or more functions or transformations) the values of one or both datasets in order to identify the data records having matching values. Additionally, in some examples, the method 700 may utilize a threshold number of matching values that are needed to determine that a data record from the first dataset matches a data record from the second dataset. For instance, if both datasets include a “name” field, and both include a data value of “John Smith” for the name field (e.g., a threshold number of one matching value), they may still refer to two different people. But if both datasets include a “phone number” field, and both include a phone number data value of “123-456-7890” in the same data record as the data value “John Smith” (e.g., a threshold number of two matching values), the two data records are more likely to refer to the same individual.

Furthermore, the method 700 may include stitching (block 710) each identified data record of the first plurality of data records with each respective identified data record of the second plurality of data records in order to generate a third dataset including a third plurality of data records having values for each of the first set of fields and for each of the second set of fields. That is, in the example discussed above, based on determining that a particular individual appears in both a dataset from a pharmacy and a dataset from a store, the patient record from the pharmacy may be combined with the customer record from the store to include a unified record including both pharmacy-related fields and store-related fields.

In some examples, the method 700 may convert (e.g., by applying one or more functions or transformations) the values of one or both datasets in order to stitch the data records together. For instance, the values of one dataset may be formatted in a particular manner, and the values of another dataset may be formatted in a different manner, so the method 700 may include converting the values of the data records of the first dataset into a format more suitable for analyzing alongside the values of the data records of the second dataset.

Additionally, the method 700 may include applying (block 712) one or more functions to the third plurality of data records of the third dataset to produce an output dataset, and displaying (block 714) the output dataset via a user interface. For instance, the method 700 may identify which functions to apply to the third dataset based on factors such as the identified fields of each dataset, the identified third set of fields in common between the dataset, etc. In some examples, one or more functions may include recommendations or predictions associated with the data records of the dataset. For instance, when each data record corresponds to an individual, the output dataset may include recommendations or predictions associated with the individual. Furthermore, in some cases, in addition to or instead of displaying the output dataset via the user interface, the method 700 may send/transmit the output dataset to an external device.

### Example Computing System

FIG. 8 depicts an exemplary computing system 102 in which the techniques described herein may be implemented, according to one embodiment. The computing system 102 of FIG. 8 may include a computing device in the form of a computer 810. Components of the computer 810 may include, but are not limited to, a processing unit 820 (e.g., corresponding to the processor 108 of FIG. 1B), a system memory 830 (e.g., corresponding to the memory 110 of FIG. 1B), and a system bus 821 that couples various system components including the system memory 830 to the processing unit 820. The system bus 821 may be any of several types of bus structures including a memory bus or memory controller, a peripheral bus, or a local bus, and may use any suitable bus architecture. By way of example, and not limitation, such architectures include the Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus (also known as Mezzanine bus).

Computer 810 may include a variety of computer-readable media. Computer-readable media may be any available media that can be accessed by computer 810 and may include both volatile and nonvolatile media, and both removable and non-removable media. By way of example, and not limitation, computer-readable media may comprise computer storage media and communication media.

Computer storage media may include volatile and nonvolatile, removable and non-removable media implemented in any method or technology for storage of information such as computer-readable instructions, data structures, program modules or other data. Computer storage media may include, but is not limited to, RAM, ROM, EEPROM, FLASH memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can accessed by computer 810.

Communication media typically embodies computer-readable instructions, data structures, program modules or other data in a modulated data signal such as a carrier wave or other transport mechanism, and may include any information delivery media. The term “modulated data signal” means a signal that has one or more of its characteristics set or changed in such a manner as to encode information in the signal. By way of example, and not limitation, communication media may include wired media such as a wired network or direct-wired connection, and wireless media such as acoustic, radio frequency (RF), infrared and other wireless media. Combinations of any of the above are also included within the scope of computer-readable media.

The system memory 830 may include computer storage media in the form of volatile and/or nonvolatile memory such as read only memory (ROM) 831 and random access memory (RAM) 832. A basic input/output system 833 (BIOS), containing the basic routines that help to transfer information between elements within computer 810, such as during start-up, is typically stored in ROM 831. RAM 832 typically contains data and/or program modules that are immediately accessible to, and/or presently being operated on, by processing unit 820. By way of example, and not limitation, FIG. 8 illustrates operating system 834, application programs 835 (e.g., corresponding to the curation framework application 112, machine learning model training application 114, and/or curation framework machine learning model 116 of FIG. 1B), other program modules 836, and program data 837.

The computer 810 may also include other removable/non-removable, volatile/nonvolatile computer storage media. By way of example only, FIG. 8 illustrates a hard disk drive 841 that reads from or writes to non-removable, nonvolatile magnetic media, a magnetic disk drive 851 that reads from or writes to a removable, nonvolatile magnetic disk 852, and an optical disk drive 855 that reads from or writes to a removable, nonvolatile optical disk 856 such as a CD ROM or other optical media. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM, and the like. The hard disk drive 841 may be connected to the system bus 821 through a non-removable memory interface such as interface 840, and magnetic disk drive 851 and optical disk drive 855 may be connected to the system bus 821 by a removable memory interface, such as interface 850.

The drives and their associated computer storage media discussed above and illustrated in FIG. 8 provide storage of computer-readable instructions, data structures, program modules and other data for the computer 810. In FIG. 8, for example, hard disk drive 841 is illustrated as storing operating system 844, application programs 845, other program modules 846, and program data 847. Note that these components may either be the same as or different from operating system 834, application programs 835, other program modules 836, and program data 837. Operating system 844, application programs 845, other program modules 846, and program data 847 are given different numbers here to illustrate that, at a minimum, they are different copies. A user may enter commands and information into the computer 810 through input devices such as cursor control device 861 (e.g., a mouse, trackball, touch pad, etc.) and keyboard 862. A monitor 891 or other type of display device is also connected to the system bus 821 via an interface, such as a video interface 890. In addition to the monitor, computers may also include other peripheral output devices such as printer 896, which may be connected through an output peripheral interface 895.

The computer 810 may operate in a networked environment using logical connections to one or more remote computers, such as a remote computer 880. The remote computer 880 may be a mobile computing device, personal computer, a server, a router, a network PC, a peer device or other common network node, and may include many or all of the elements described above relative to the computer 810, although only a memory storage device 881 has been illustrated in FIG. 8. The logical connections depicted in FIG. 8 include a local area network (LAN) 871 and a wide area network (WAN) 873 (e.g., either or both of which may correspond to the network 108 of FIG. 1B), but may also include other networks. Such networking environments are commonplace in hospitals, offices, enterprise-wide computer networks, intranets and the Internet.

When used in a LAN networking environment, the computer 810 is connected to the LAN 871 through a network interface or adapter 870. When used in a WAN networking environment, the computer 810 may include a modem 872 or other means for establishing communications over the WAN 873, such as the Internet. The modem 872, which may be internal or external, may be connected to the system bus 821 via the input interface 860, or other appropriate mechanism. The communications connections 870, 872, which allow the device to communicate with other devices, are an example of communication media, as discussed above. In a networked environment, program modules depicted relative to the computer 810, or portions thereof, may be stored in the remote memory storage device 881. By way of example, and not limitation, FIG. 8 illustrates remote application programs 885 as residing on memory device 881.

The techniques for using configurable functions to harmonize data from disparate sources described above may be implemented in part or in their entirety within a computing system such as the computing system 102 illustrated in FIG. 8. In some such embodiments, the LAN 871 or the WAN 873 may be omitted. Application programs 835 and 845 may include a software application (e.g., a web-browser application) that is included in a user interface, for example.

### Additional Considerations

The following additional considerations apply to the foregoing discussion. Throughout this specification, plural instances may implement operations or structures described as a single instance. Although individual operations of one or more methods are illustrated and described as separate operations, one or more of the individual operations may be performed concurrently, and nothing requires that the operations be performed in the order illustrated. These and other variations, modifications, additions, and improvements fall within the scope of the subject matter herein.

Unless specifically stated otherwise, discussions herein using words such as “processing,” “computing,” “calculating,” “determining,” “presenting,” “displaying,” or the like may refer to actions or processes of a machine (e.g., a computer) that manipulates or transforms data represented as physical (e.g., electronic, magnetic, or optical) quantities within one or more memories (e.g., volatile memory, non-volatile memory, or a combination thereof), registers, or other machine components that receive, store, transmit, or display information.

As used herein any reference to “one embodiment” or “an embodiment” or “some embodiments” means that a particular element, feature, structure, or characteristic described in connection with the embodiment is included in at least one embodiment. The appearances of the phrase “in one embodiment” or “in some embodiments” in various places in the specification are not necessarily all referring to the same embodiment.

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

In addition, use of “a” or “an” is employed to describe elements and components of the embodiments herein. This is done merely for convenience and to give a general sense of the invention. This description should be read to include one or at least one and the singular also includes the plural unless it is obvious that it is meant otherwise.

Upon reading this disclosure, those of skill in the art will appreciate still additional alternative structural and functional designs for using configurable functions to harmonize data from disparate sources. Thus, while particular embodiments and applications have been illustrated and described, it is to be understood that the disclosed embodiments are not limited to the precise construction and components disclosed herein. Various modifications, changes and variations, which will be apparent to those skilled in the art, may be made in the arrangement, operation and details of the method and apparatus disclosed herein without departing from the spirit and scope defined in the appended claims.

What is claimed is:

1. A computer-implemented method for using configurable functions to harmonize data from disparate sources, comprising:
retrieving, by one or more processors, a first dataset from a first external data source, the first dataset including a first plurality of data records having values for each of a first set of fields;
retrieving, by the one or more processors, a second dataset from a second external data source, distinct from the first external data source, the second dataset including a second plurality of data records having values for each of a second set of fields;
analyzing, by the one or more processors, the first set of fields and the second set of fields to identify a third set of fields, the third set of fields being fields included in both the first set of fields and the second set of fields;
identifying, by the one or more processors, one or more data records of the first plurality of data records, and one or more respective data records of the second plurality of data records, having matching values for fields of the third set of fields;
stitching, by the one or more processors, each identified data record of the first plurality of data records with each respective identified data record of the second plurality of data records in order to generate a third dataset including a third plurality of data records having values for each of the first set of fields and for each of the second set of fields;
applying, by the one or more processors, one or more functions to the third plurality of data records of the third dataset to produce an output dataset; and
displaying, by the one or more processors, the output dataset via a user interface.

2. The method of claim 1, further comprising:
analyzing, by the one or more processors, the first dataset in order to identify the first set of fields; and
analyzing, by the one or more processors, the second dataset in order to identify the second set of fields.

3. The method of claim 2, wherein analyzing the first dataset in order to identify the first set of fields includes analyzing the respective values of each field of the first set of fields in order to identify the first set of fields, and wherein analyzing the second dataset in order to identify the second set of fields includes analyzing the respective values of each field of the second set of fields in order to identify the second set of fields.

4. The method of claim 1, wherein identifying one or more data records of the first plurality of data records, and one or more respective data records of the second plurality of data records, having matching values for the third set of fields further comprises:
converting, by the one or more processors, one or more values for a field of the third set of fields in the first dataset from a first format associated with the first dataset to a second format associated with the second dataset; and
comparing, by the one or more processors, the converted one or more values for the field of the third set of fields in the first dataset to one or more values for the field of the third set of fields in the second dataset in order to identify the one or more data records of the first plurality of data records, and one or more respective data records of the second plurality of data records, having matching values for the third set of fields.

5. The method of claim 1, further comprising:
accessing, by the one or more processors, a library of pre-built functions; and
identifying, by the one or more processors, the one or more functions to be applied to the third dataset.

6. The method of claim 5, wherein identifying the one or more functions to be applied to the third dataset is based on the identified fields of the third set of fields.

7. The method of claim 1, wherein each data record of the third dataset is associated with an individual, and wherein the output dataset includes recommendations or predictions for the individuals associated with the data records of the third dataset.

8. A computer system for comprising one or more processors, and one or more memories storing non-transitory computer-readable instructions for using configurable functions to harmonize data from disparate sources, that, when executed by one or more processors, cause the one or more processors to:
retrieve a first dataset from a first external data source, the first dataset including a first plurality of data records having values for each of a first set of fields;
retrieve a second dataset from a second external data source, distinct from the first external data source, the second dataset including a second plurality of data records having values for each of a second set of fields;
analyze the first set of fields and the second set of fields to identify a third set of fields, the third set of fields being fields included in both the first set of fields and the second set of fields;
identify one or more data records of the first plurality of data records, and one or more respective data records of the second plurality of data records, having matching values for the third set of fields;
stitch each identified data record of the first plurality of data records with each respective identified data record of the second plurality of data records in order to generate a third dataset including a third plurality of data records having values for each of the first set of fields and for each of the second set of fields;
apply one or more functions to the third plurality of data records of the third dataset to produce an output dataset; and
display the output dataset via a user interface.

9. The computer system of claim 8, wherein the instructions, when executed by the one or more processors, further cause the one or more processors to:
analyze the first dataset in order to identify the first set of fields; and
analyze the second dataset in order to identify the second set of fields.

10. The computer system of claim 9, wherein analyzing the first dataset in order to identify the first set of fields includes analyzing the respective values of each field of the first set of fields in order to identify the first set of fields, and wherein analyzing the second dataset in order to identify the second set of fields includes analyzing the respective values of each field of the second set of fields in order to identify the second set of fields.

11. The computer system of claim 8, wherein identifying one or more data records of the first plurality of data records, and one or more respective data records of the second plurality of data records, having matching values for the third set of fields includes:
converting one or more values for a field of the third set of fields in the first dataset from a first format associated with the first dataset to a second format associated with the second dataset; and
comparing the converted one or more values for the field of the third set of fields in the first dataset to one or more values for the field of the third set of fields in the second dataset in order to identify the one or more data records of the first plurality of data records, and one or more respective data records of the second plurality of data records, having matching values for the third set of fields.

12. The computer system of claim 8, wherein the instructions, when executed by the one or more processors, further cause the one or more processors to:
access a library of pre-built functions; and
identify the one or more functions to be applied to the third dataset.

13. The computer system of claim 12, wherein identifying the one or more functions to be applied to the third dataset is based on the identified fields of the third set of fields.

14. The computer system of claim 8, wherein each data record of the third dataset is associated with an individual, and wherein the output dataset includes recommendations or predictions for the individuals associated with the data records of the third dataset.

15. A non-transitory computer-readable medium storing instructions for using configurable functions to harmonize data from disparate sources that, when executed by one or more processors, cause the one or more processors to:
retrieve a first dataset from a first external data source, the first dataset including a first plurality of data records having values for each of a first set of fields;
retrieve a second dataset from a second external data source, distinct from the first external data source, the second dataset including a second plurality of data records having values for each of a second set of fields;
analyze the first set of fields and the second set of fields to identify a third set of fields, the third set of fields being fields included in both the first set of fields and the second set of fields;
identify one or more data records of the first plurality of data records, and one or more respective data records of the second plurality of data records, having matching values for the third set of fields;
stitch each identified data record of the first plurality of data records with each respective identified data record of the second plurality of data records in order to generate a third dataset including a third plurality of data records having values for each of the first set of fields and for each of the second set of fields;
apply one or more functions to the third plurality of data records of the third dataset to produce an output dataset; and
display the output dataset via a user interface.

16. The non-transitory computer-readable medium of claim 15, wherein the instructions, when executed by the one or more processors, further cause the one or more processors to:
analyze the first dataset in order to identify the first set of fields; and
analyze the second dataset in order to identify the second set of fields.

17. The non-transitory computer-readable medium of claim 16, wherein analyzing the first dataset in order to identify the first set of fields includes analyzing the respective values of each field of the first set of fields in order to identify the first set of fields, and wherein analyzing the second dataset in order to identify the second set of fields includes analyzing the respective values of each field of the second set of fields in order to identify the second set of fields.

18. The non-transitory computer-readable medium of claim 15, wherein identifying one or more data records of the first plurality of data records, and one or more respective data records of the second plurality of data records, having matching values for the third set of fields includes:
converting one or more values for a field of the third set of fields in the first dataset from a first format associated with the first dataset to a second format associated with the second dataset; and
comparing the converted one or more values for the field of the third set of fields in the first dataset to one or more values for the field of the third set of fields in the second dataset in order to identify the one or more data records of the first plurality of data records, and one or more respective data records of the second plurality of data records, having matching values for the third set of fields.

19. The non-transitory computer-readable medium of claim 15, wherein the instructions, when executed by the one or more processors, further cause the one or more processors to:
access a library of pre-built functions; and
identify the one or more functions to be applied to the third dataset.

20. The non-transitory computer-readable medium of claim 15, wherein identifying the one or more functions to be applied to the third dataset is based on the identified fields of the third set of fields.
